(19) United States
(12) Patent Application Publication
(10) Pub. No.: US 2010/0271827 A1
(43) Pub. Date: Oct. 28, 2010

(54) LED linear reflection lighting

(76) Inventors: Joseph Chou, Temple City, CA (US); Neng-Tze Yang, Hermosa Beach, CA (US)

Correspondence Address: DAVID AND RAYMOND PATENT FIRM, 108 N. YNEZ AVE., SUITE 128, MONTEREY PARK, CA, 91754, US

(21) Appl. No.: 12/386,880

(22) Filed: Apr. 24, 2009

(51) Int. Cl. F21V 7/00

(52) U.S. Cl. 362/296.01

(57) ABSTRACT

A LED lighting includes an illuminator and a reflection housing. The illuminator provides the light. The reflection housing receives and holds the illuminator, and patterns the light illuminated by the illuminator. The reflection housing includes an illuminator end, a linear reflection surface, and a light opening. The illuminator end, the linear reflection surface, and the light opening define a conical cavity which has a shape of right circular cone. The illuminator end is at the apex of the conical cavity, the lighting opening is at the bottom of the conical cavity with a circular shape, and the conical linear reflection surface is the lateral surface of the conical cavity.

### BACKGROUND OF THE PRESENT INVENTION

1. Field of Invention

The present invention relates to lighting, and more particularly to an LED lighting using linear reflection.

2. Description of Related Arts

LED lightings are widely used these days for its numerous benefits such as energy saving, small size, long life, and durability. However, currently the overall light output of LED is still relatively low, extra apparatus are needed to concentrate the light output for increasing the intension.

LED is a solid state semiconductor device. It directly produces visible light when the semiconductor crystal is excited. It can be regarded as a small area light source and project light radially. Generally the semiconductor crystal is packed in a transparent package to shape its light beam patterns. The light beam patterns are typically within 90 to 120 degree angles. For a standard 110 degree LED, the relative luminous intensity is illustrated in FIG. 1. Referring to FIG. 1, the intensity is the highest at zero degree angle and drops to 50% at +/−55 degree. The light spread in a large angle of range. The relative luminous flux is about peaked within the 30 to 40 degree range.

Most of existing LED lightings is more or less following the output beam patterns. As mentioned above, this performance is not efficient, and wastes a lot of energy. If not sufficient brightness can be provided, LED with higher power is needed. Obviously this will cost more, and generate more heat. One solution is using single reflection curved surface to focus the LED light for the desired light patterns. For example, the reflection curved surface is parabolic. The LED light source is location on the focal point of the parabolic body and projecting light onto the reflection curved surface. The light rays are reflected once by the surface to form a parallel beam. This will concentrate the light in a limited area (spot). But the curved linear reflection surface still has a problem. Since the light ray with the zero degree will be reflected in the same path, and will be blocked by the LED itself, at the same time all other light rays are reflected in parallel, a black spot is formed in the center of the light beam. It needs to be avoid because most of the time the center of the light beam should have the highest brightness.

All the disadvantages largely limit the application of LED used in lightings. For example, a lamp using LED as illuminator has to utilize more LEDs for sufficient illumination which already increases the cost. At the same time, additional equipment has to be supplied to release the heat generated by these extra LEDs, and of course, more energy is consumed. It is a big waste due to all these shortcomings.

### SUMMARY OF THE PRESENT INVENTION

The main object of the present invention is to provide a LED lighting to increase the light output efficiency.

Another object of the present invention is to provide a LED lighting to increase the brightness.

Another object of the present invention is to provide a LED lighting to focus the light beam of the light output.

Another object of the present invention is to provide a LED lighting to reduce the energy consumption.

Another object of the present invention is to provide a LED lighting to reduce the heat generating.

Another object of the present invention is to provide a LED lighting to regulate the light beam patterns.

Another object of the present invention is to provide a LED lighting to regulate the distribution of the LED light output.

Another object of the present invention is to provide a LED lighting which is easy to fabricate.

Accordingly, in order to accomplish the above objects, the present invention provides a LED light apparatus, comprising:

a reflection housing which comprises an illuminator end, a light opening coaxially aligning with the illuminator end, and a linear reflection surface extending from the illuminator end towards the light opening, wherein the reflection surface has a linear wall; and

an illuminator positioned at the illuminator end of the linear reflection housing, wherein the illuminator comprises a light head projecting light towards the light opening of the reflection housing, wherein the linear reflection surface of the reflection housing reflects the light projected thereon from the light head towards the light opening in such a manner that the reflection housing is adapted to convert a wide-angle-beam output of the light head to a narrow-angle-beam output so as to enhance a light intensity of the illuminator through the reflection housing.

These and other objectives, features, and advantages of the present invention will become apparent from the following detailed description, the accompanying drawings, and the appended claims.

### BRIEF DESCRIPTION OF THE DRAWINGS

FIG. 1 illustrates a typical spatial distribution for a 110 degree LED.

FIG. 2 is a sectional view of a LED linear reflection lighting according to a preferred embodiment of the present invention.

FIG. 3 is a top view of the LED linear reflection lighting according to above preferred embodiment of the present invention.

FIG. 4 is a schematic view of the LED linear reflection lighting according to the above preferred embodiment of the present invention, illustrating the reflection housing in single-reflection mode.

FIG. 5 is a schematic view of the LED linear reflection lighting according to the above preferred embodiment of the present invention, illustrating the reflection housing in piecewise-linear mode.

FIG. 6 is a perspective view of the LED linear reflection lighting according to the above preferred embodiment of the present invention.

FIG. 7 is a perspective view of a spot-light application of the LED linear reflection lighting according to the above preferred embodiment of the present invention.

FIG. 8 is an alternative embodiment of the LED linear reflection lighting according to the above preferred embodiment of the present invention.

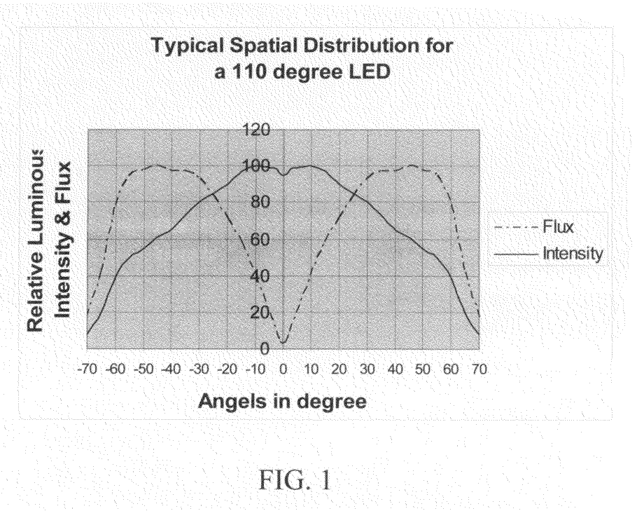

### DETAILED DESCRIPTION OF THE PREFERRED EMBODIMENT

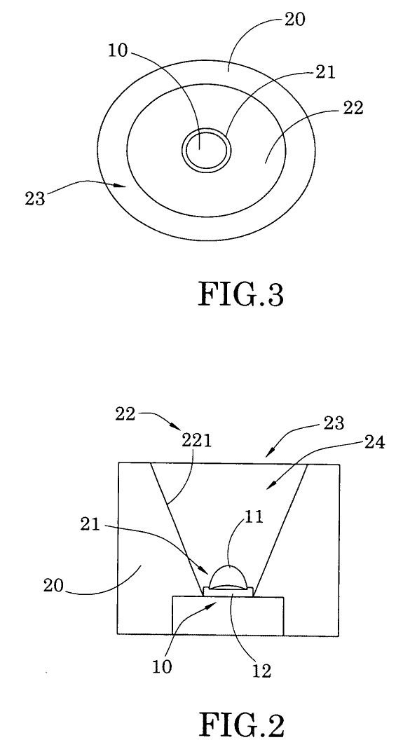

Referring to FIGS. 2 and 3 of the drawings, in a preferred embodiment of the present invention, a LED linear reflection lighting, which is a LED lighting apparatus, comprises an illuminator 10 and a linear reflection housing 20. The illuminator 10 provides the light. The linear reflection housing 20 receives and holds the illuminator 10, and patterns the light illuminated by the illuminator 10.

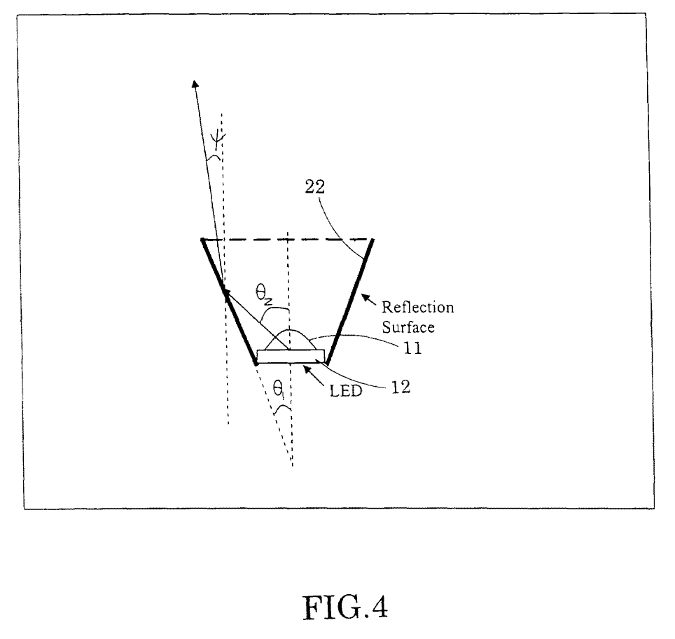

Referring to FIGS. 2 and 3, in a preferred embodiment of the present invention, the illuminator 10 is a LED. The reflection housing 20 comprises an illuminator end 21, a linear reflection surface 22, and a light opening 23. The illuminator end 21, the linear reflection surface 22, and the light opening 23 define a conical cavity 24 which has a shape of right circular cone. The illuminator end 21 is at the apex of the conical cavity 24, the lighting opening is at the bottom of the conical cavity 24 with a circular shape, and the conical linear reflection surface 22 is the lateral surface of the conical cavity 24. Referring to FIG. 4, in a preferred embodiment of the present invention, the linear reflection surface 22 has a linear wall 221 which is leaning from the bottom to the apex of the conical cavity 24 with a uniform linear slope and defines an inclination angle θ₁. The inclination angle is the angle between the vertical axis of the conical cavity 24 and the linear line on the wall of the linear reflection surface 22. It is also the half-angle of the cone of the conical cavity 24. The inclination angle varies in different embodiments. Preferably, the inclination angle is in the range of 25° to 40°.

In the preferred embodiment, the illuminator 10 is a LED which comprises a light head 11 and a base 12. The base 12 of the LED is received by the illuminator end 21 of the reflection housing 20. The light head 11 of the LED is exposed to the conical cavity 24 facing to the light opening 23 of the reflection housing 20. The vertical axis of the LED and the vertical axis of the conical cavity 24 are overlapped. When the LED is illuminating light, the light ray has a projection angle with the vertical axis. For the standard 90 degree LED, the maximum projection angle θ₂ is 45 degree. For the standard 120 degree LED, the maximum projection angle θ₂ is 60 degree. When the light ray has a projection angle θ₂ which is smaller than the inclination angle θ₁ of the linear reflection surface 22, it can be projected out of the reflection housing 20 from the light opening 23 directly. When the LED light is projected onto the linear reflection surface 22 which is made of material reflecting light efficiently or coated with reflecting materials, it will be reflected and get out of the reflection housing 20 from the light opening 23 with an output angle ψ with the vertical axis. In this way, the output angle of the light beam of the LED is narrowed. The light spot is focused. Consequently, the light intensity is largely increased within the light spot, which means, the light is much brighter. Referring to FIG. 4, the relationship of these angles is:

Ψ=2θ₁−θ₂

When the θ₂ is about 55 degree, and the inclination angle θ₁ of the linear reflection surface 22 is 30 degree, the output of the LED will be converted to a narrow angle beam, which is about 5 degree. Because the LED lighting source 20 is not necessary to be assembled on a focal point, it is much convenient for assembly.

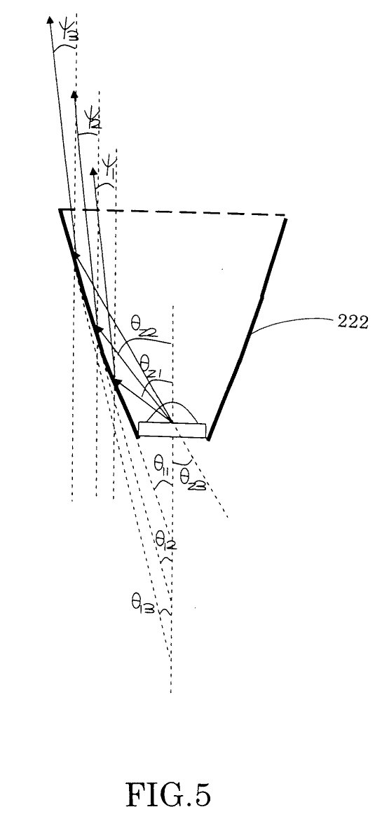

In an alternative embodiment of the present invention, the conical cavity 24 is not in a right circular cone shape. Referring to FIG. 5, the linear reflection surface 22 consists of a plurality of linear sections 222 with discrete inclination angles. Each linear section is a portion of a cone with an inclination angle. These linear sections 222 are connected together to define the conical cavity 24. The linear sections 222 closing to the apex of the conical cavity 24 have larger inclination angles, and the linear sections 222 closing to the bottom of the conical cavity 24 have smaller inclination angles. Referring to FIG. 5, in one embodiment, the linear reflection surface 22 consists of 3 linear sections 222 which have 3 inclination angles θ₁₁, θ₁₂, and θ₁₃ respectively. The light rays projected onto the linear sections 222 have the projection angles θ₂₁, θ₂₂, and θ₂₃ respectively. According to the relationship of the angles, the 3 linear sections 222 have 3 output angles ψ₁, ψ₂, and ψ₃. With proper inclination angles, and dimensions, each linear section can have a same output beam angle to narrow the output of the LED.

Because of using the reflection housing, the efficiency of the LED is highly increased. To achieve the same illumination effect, much less electric power is needed, the current passes through the LED can be largely reduced, for example, reduced in half. Consequently, much less heat is generated. The reflection housing 20 doesn't need to be equipped with any heat releasing equipment such as a fin. The thermal problem, which is one of the biggest problems of using LED, is solved by the present invention. No special device is needed, the cost is reduced.

It is worth mentioning, the light opening 23 of the reflection housing 20 can be opened. Alternatively, the reflection housing 20 further comprises a cover covering the light opening 23. The cover can protect the LED such as proof dust and insect. The cover is made of transparent material to pass the light. It can also be made of colorful material for pass special color of the light.

The reflection housing can be integrated with the LED during the LED packaging. In this embodiment the illuminator 10 comprises a diode 13. The diode is electrically coupled with a circuit base 14. The diode 13 and the circuit base 14 are packaged by resin 15 to form a lens head. Referring to FIG. 8, in an alternative embodiment of the present invention, the reflection housing 20 and the diode 13 are packaged together directly.

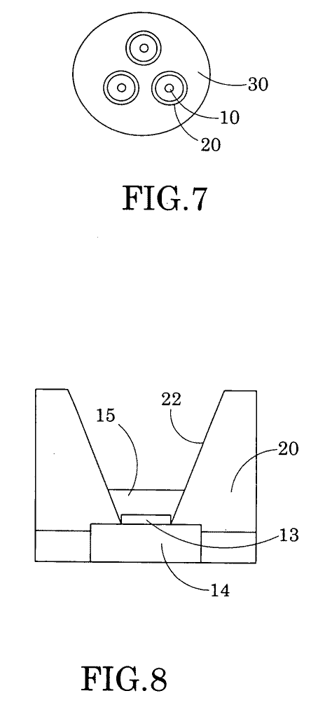

The present invention can be applied in many different ways. The LED lighting can be used individually to provide a light spot, or be used in a matrix to illuminate a large area. Referring to FIG. 7, in one embodiment, three of the LED lightings of the present invention are arranged in parallel to provide illumination to a relative small area. This arrangement can be used as a desk lamp.

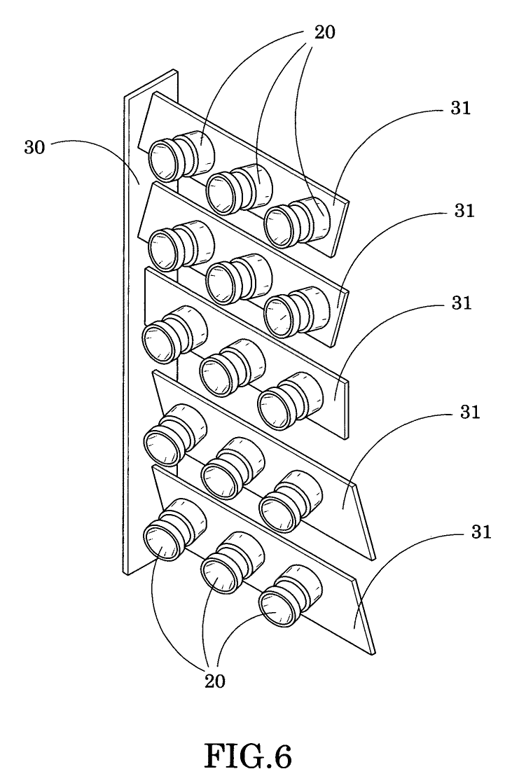

Referring to FIG. 6, in another embodiment, a plurality of LED lightings of the present invention are arranged in a matrix, for example, a 3×5 matrix. The matrix comprises a supporting frame 30 and 5 supporting lines 31 having 3 LED lightings assembled thereon. Each supporting line of the matrix can be rotated on the frame so the projection directions of the LED lightings of each line can be adjusted respectively. By adjusting the supporting lines, to LED lightings can project light radially to illuminate a relatively large area. The application can be used for large area illumination such as street lights.

The present invention provides an efficient LED lighting. It is easy to fabricate and to install, energy saving, and safe. It generates less heat, consume less energy, and provide better illumination.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A LED linear reflection lighting, comprising:
a reflection housing which comprises an illuminator end, a light opening coaxially aligning with said illuminator end, and a linear reflection surface extending from said illuminator end towards said light opening, wherein said reflection surface has a linear wall; and
an illuminator positioned at said illuminator end of said linear reflection housing, wherein said illuminator comprises a light head projecting light towards said light opening of said reflection housing, wherein said linear reflection surface of said reflection housing reflects said light projected thereon from said light head towards said light opening in such a manner that said reflection housing is adapted to convert a wide-angle-beam output of said light head to a narrow-angle-beam output so as to enhance a light intensity of said illuminator through said reflection housing.

2. The LED linear reflection lighting, as recited in claim 1, wherein said linear wall of said linear reflection surface has a uniform linear slope and defines an inclination angle.

3. The LED linear reflection lighting, as recited in claim 2, wherein said inclination angle of said linear reflection surface has a range between 25° to 40° with respect to a centerline of said reflection housing.

4. The LED linear reflection lighting, as recited in claim 1, wherein said inclination angle is smaller than the maximum projection angle of the light beam of said illuminator.

5. The LED linear reflection lighting, as recited in claim 2, wherein said inclination angle is smaller than the maximum projection angle of the light beam of said illuminator.

6. The LED linear reflection lighting, as recited in claim 3, wherein said inclination angle is smaller than the maximum projection angle of the light beam of said illuminator.

7. The LED linear reflection lighting, as recited in claim 4, wherein said light head is a LED light with said maximum projection angle having a range between 45° to 60° with respect to a centerline of said reflection housing.

8. The LED linear reflection lighting, as recited in claim 5, wherein said light head is a LED light with said maximum projection angle having a range between 45° to 60° with respect to a centerline of said reflection housing.

9. The LED linear reflection lighting, as recited in claim 6, wherein said light head is a LED light with said maximum projection angle having a range between 45° to 60° with respect to a centerline of said reflection housing.

10. The LED linear reflection lighting, as recited in claim 4, wherein said light head comprises a circuit base and a diode electrically coupling thereon to support at said illuminator end of said reflection housing, wherein said diode with said maximum projection angle has a range between 45° to 60° with respect to a centerline of said reflection housing.

11. The LED linear reflection lighting, as recited in claim 5, wherein said light head comprises a circuit base and a diode electrically coupling thereon to support at said illuminator end of said reflection housing, wherein said diode with said maximum projection angle has a range between 45° to 60° with respect to a centerline of said reflection housing.

12. The LED linear reflection lighting, as recited in claim 6, wherein said light head comprises a circuit base and a diode electrically coupling thereon to support at said illuminator end of said reflection housing, wherein said diode with said maximum projection angle has a range between 45° to 60° with respect to a centerline of said reflection housing.

13. The LED linear reflection lighting, as recited in claim 1, wherein said linear reflection surface of said reflection housing has a plurality of discrete reflection surfaces integrally extended from said illuminator end to said light opening, wherein each of said discrete reflection surface has a linear slope and defines a corresponding inclination angle.

14. The LED linear reflection lighting, as recited in claim 9, wherein said linear reflection surface of said reflection housing has a plurality of discrete reflection surfaces integrally extended from said illuminator end to said light opening, wherein each of said discrete reflection surface has a linear slope and defines a corresponding inclination angle.

15. The LED linear reflection lighting, as recited in claim 12, wherein said linear reflection surface of said reflection housing has a plurality of discrete reflection surfaces integrally extended from said illuminator end to said light opening, wherein each of said discrete reflection surface has a linear slope and defines a corresponding inclination angle.

16. The LED linear reflection lighting, as recited in claim 13, wherein output angles of said discrete reflection surfaces are identical when said light projects to said discrete reflection surfaces.

17. The LED linear reflection lighting, as recited in claim 14, wherein output angles of said discrete reflection surfaces are identical when said light projects to said discrete reflection surfaces.

18. The LED linear reflection lighting, as recited in claim 15, wherein output angles of said discrete reflection surfaces are identical when said light projects to said discrete reflection surfaces.

19. The LED linear reflection lighting, as recited in claim 14, further comprising a supporting frame, wherein said reflection housing is rotatably coupled at said supporting frame at said illuminator end thereof to selectively adjust an orientation of said light opening of said reflection housing.

20. The LED linear reflection lighting, as recited in claim 15, further comprising a supporting frame, wherein said reflection housing is rotatably coupled at said supporting frame at said illuminator end thereof to selectively adjust an orientation of said light opening of said reflection housing.
